(19) United States
(12) Patent Application Publication
(10) Pub. No.: US 2015/0340895 A1
(43) Pub. Date: Nov. 26, 2015

(54) Portable Electrical Charging Device With Timer Function

(71) Applicants: Sharmila Vijay Salvi, London (GB); Robin Nagji, London (GB)

(72) Inventors: Sharmila Vijay Salvi, London (GB); Robin Nagji, London (GB)

(21) Appl. No.: 14/716,663

(22) Filed: May 19, 2015

(30) Foreign Application Priority Data
May 20, 2014 (GB) GB1408894.2

(51) Int. Cl. H02J 7/00

(52) U.S. Cl. CPC H02J 7/0045; H02J 7/0047

(57) ABSTRACT

A portable electrical charging device has a rechargeable battery, an electrical charge outlet by which said rechargeable battery provides an electrical charge, and a control circuit. The control circuit has a timer function. The control circuit permits an electrical charge to be drawn from the electrical charge outlet for a pre-determined period of time only, by reference to the timer function.

This invention relates to a portable electrical charging device with a timer function, which is for use particularly, but not exclusively, as a temporary mobile phone charger.

Mobile phones and other portable electronic devices are powered by rechargeable batteries. To maintain their functionality the battery must carry sufficient charge to operate the device, or the device must be connected to an external supply of electrical charge. If the battery runs out of charge, and no external supply of electrical charge is available, then the device will switch off, which is a ubiquitous modern inconvenience. In the home or office a mains supply of electricity is usually available to recharge or operate such mobile devices, but in a public space such facilities are often not available.

It is known to provide portable electrical charging devices which comprise a rechargeable battery, an electrical charge inlet by which the rechargeable battery can draw an electrical charge for storage, for example directly from a mains electricity supply or a via PC, and an electrical charge outlet by which the rechargeable battery can provide an electrical charge to a mobile device. The electrical charge inlet and outlet can be any known electrical connectors or plugs, and they can be manifested in a single plug, for example a USB or Ethernet plug. Such portable electrical charging devices can therefore be charged with electrical power at a convenient time and location, and then relied upon to operate or charge a portable electrical device when no other source of electrical charge is available.

It is now desired to provide such portable electrical charging devices to members of the public as a service. Such a service would find particular application in locations where members of the public congregate, such as cafes, restaurants, hotels, spas, beauty salons, hospitals and so on. At present such locations may allow users access to a mains electricity supply in order to operate or charge a portable electrical device, however this is problematic because such power usage cannot be readily controlled or monitored, and therefore billed for. The provision of portable charging devices as a paid for service would overcome these problems.

However, there are issues associated with this business model. In particular, it is necessary to control the amount of electrical charge a customer may use, so it can be charged fairly and accurately. In addition it is also necessary to provide some kind of security measure to prevent the portable charging devices being stolen by customers.

The present invention is intended to overcome some of these problems.

Therefore according to the present invention a portable electrical charging device comprises a rechargeable battery, an electrical charge outlet by which said rechargeable battery provides an electrical charge, and a control circuit, in which said control circuit comprises a timer function, and in which said control circuit permits an electrical charge to be drawn from said electrical charge outlet for a pre-determined period of time only, by reference to said timer function.

Thus, the portable electrical charging device of the present invention will only provide its user with an electrical charge for this pre-determined period of time, which can be any duration, but which is preferably 30 minutes. This allows a service provider to charge a suitable and fair sum for the service, which can be based on the value of electrical power in the local area. It also serves as a security measure against theft as the charging device is no longer of any value to a user once the pre-determined period of time has elapsed.

In a preferred embodiment the device can further comprise an electrical charge inlet by which the rechargeable battery can draw an electrical charge for storage, and the control circuit can comprise a first monitoring function which can detect the drawing of an electrical charge by the rechargeable battery. Furthermore, the control circuit can be configured to only permit an electrical charge to be drawn from the electrical charge outlet for the pre-determined period of time, after it has detected the drawing of an electrical charge by the rechargeable battery.

With this arrangement the charging device can only be re-used once it has been re-connected to its own charging apparatus, which can be for the purposes of recharging it, or just very briefly for the purposes of re-setting the timer function. This feature provides an added security measure against theft, in particular if the charging apparatus is unique, or at least not a commonly used mechanism. There would be no motivation to steal the charging device if the electrical charge inlet was difficult to use.

In addition, this arrangement also provides a very simple re-set mechanism which a service provider can use, which would be easier and quicker to action than a control interface which has to be interacted with.

In one version of the invention the control circuit can be configured to allow a pre-determined period of charging to take place, regardless of whether that period of charging is continuous or interrupted. As such, if a user stopped using the charging device for a period, the timer function would stop. It would then begin again when the user began to use the charging device once more to operate or charge their mobile device. However, such an arrangement would increase the likelihood that a user could retain the charging device for use later.

Therefore, in a preferred construction the control circuit can comprise a second monitoring function which can detect the drawing of an electrical charge from the electrical charge outlet, and once the control circuit detects the drawing of an electrical charge from the electrical charge outlet it can activate the timer function. Further, the control circuit can be configured to prevent electrical charge being drawn from the electrical charge outlet after the pre-determined period of time has elapsed regardless of whether an electrical charge is drawn from said electrical charge outlet after said timer function has been activated.

As such, the charging device would no longer have any utility to a user beyond 30 minutes of first using it to operate or charge a mobile device, which would make it a less attractive object to steal.

Preferably the charging device can comprise a visual display to indicate its status. This can display a first signal after the control circuit has detected the drawing of an electrical charge by the rechargeable battery, a second signal after an electrical charge has been drawn from the electrical charge outlet, but prior to the end of the pre-determined period of time, and a third signal after an electrical charge has been drawn from the electrical charge outlet for the pre-determined period of time. It will be appreciated that any kind of known visual display can be used to facilitate these features, including an LCD screen or the like. However, preferably the signals can be provided by LEDs, and in particular the third signal can be provided by a flashing LED.

In another version of the invention the second signal can be a visual clock displaying the time remaining of the pre-determined period of time. This would have the advantage that a user would know how much longer their charging device would continue to operate.

As referred to above, the charging device can have its own charging apparatus, which is preferably an uncommon system in order to deter theft. One such system is a so-called contact-point wireless charging plate. These are known, and comprise a magnetic connection between a charging plate and exposed conductors of a device to be charged. The device is simply placed flat on the charging plate in order to facilitate the electrical connection, which is a very simple and easy system to use, but it does require the correct type of charging plate to be used.

Therefore, in a preferred construction the charging device can comprise an outer enclosure, and the electrical charge inlet can comprise a contact-point wireless charging mechanism comprising a first magnetic conductor and a second magnetic conductor. An inner end of the first magnetic conductor can be connected to a positive terminal of the rechargeable battery and an outer end of the first magnetic conductor can be disposed in a first aperture provided in the outer enclosure. Likewise, an inner end of the second magnetic conductor can be connected to a negative terminal of the rechargeable battery and an outer end of the second magnetic conductor can be disposed in a second aperture provided in the outer enclosure. The first aperture and the second aperture can be disposed in the same plane, and can be spaced apart from one another in that plane. Further, the portable electrical charging device can further comprise a contact-point wireless electromagnetic charging plate comprising a positive panel and a negative panel. The charging device can be disposable on the charging plate with the first aperture aligned with the positive panel and the second aperture aligned with the negative panel.

As referred to above, the charging device of the invention is for charging known kinds of portable electronic device, such as a mobile phone. Therefore, the electrical charge outlet can comprise one of the known kinds of mobile phone connection plugs, for example an Apple® or Samsung® connection plug. Some connection plugs of this kind can draw electrical charge from an associated connection, but in the present case such a plug would be adapted to not be capable of receiving an electrical charge, so it could not be used to recharge the rechargeable battery.

In order to increase the utility of the charging device, more than one such connection plug can be provided, so more than one mobile device can be connected. Therefore, in one version of the invention the electrical charge outlet can comprise at least two electrical charging plugs, each capable of being connected to an electrical device to be charged.

As there are two main kinds of such mobile phone connection plug, the at least two electrical charging plugs can be a different shape and configuration from one another.

The invention can be performed in various ways, but one embodiment will now be described by way of example, and with reference to the accompanying drawings, in which:

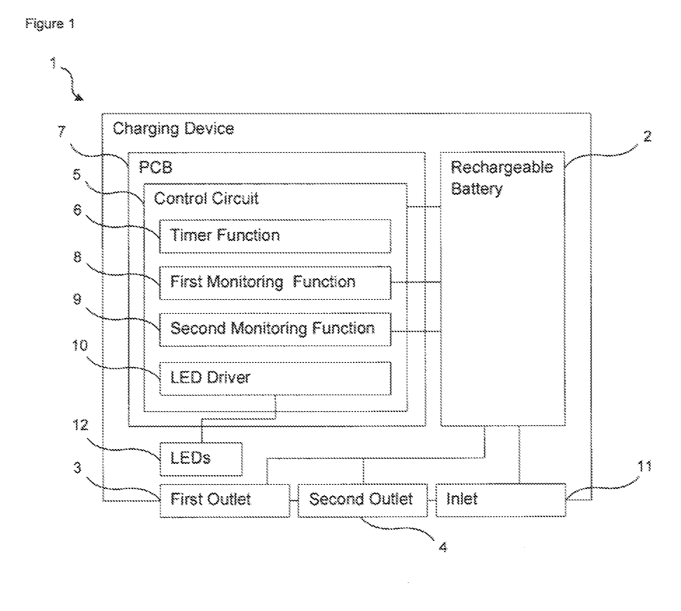

FIG. 1 is a diagrammatic view of a portable electrical charging device according to the present invention;

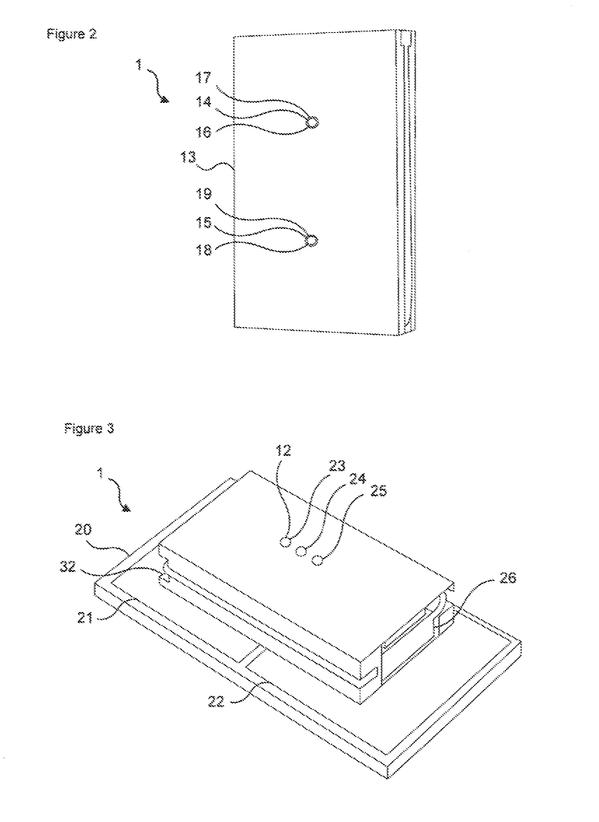

FIG. 2 is a rear perspective view of the portable electrical charging device diagrammatically displayed in FIG. 1;

FIG. 3 is a front perspective view of the portable electrical charging device diagrammatically displayed in FIG. 1 in a first use configuration; and

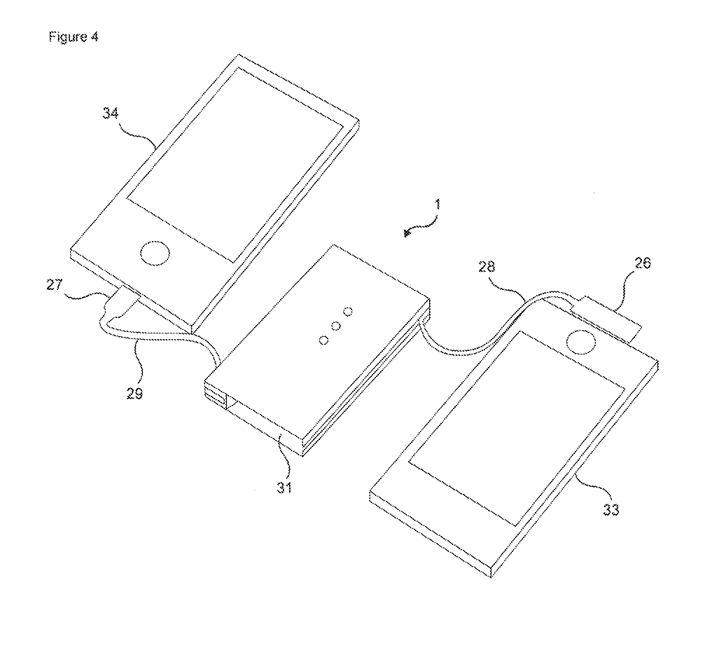

FIG. 4 is a perspective view of the portable electrical charging device diagrammatically displayed in FIG. 1, in a second use configuration.

As shown in FIG. 1, a portable electrical charging device 1 comprises a rechargeable battery 2, an electrical charge outlet, in the form of first outlet 3 and second outlet 4, by which the rechargeable battery 2 provides an electrical charge, and a control circuit 5. The control circuit 5 comprises a timer function 6, and as explained further below, the control circuit 5 permits an electrical charge to be drawn from the electrical charge outlet 3 or 4 for a pre-determined period of time only, by reference to the timer function 6.

FIG. 1 is a diagrammatic view of the present invention which is provided for illustrative purposes. The features shown in FIG. 1 are displayed according to their function, and there relationship with other features. It will be appreciated that a skilled person would be able to implement the invention shown in FIG. 1 in physical form by reference to their common general knowledge of basic electronics. In particular, the control circuit 5 can be any know kind of programmable mechanism, and the software code used to facilitate the various functions described herein could be in any known coding language.

The charging device 1 comprises a PCB 7, on which the control circuit 5 is implemented. The control circuit 5 comprises the timer function 6, a first monitoring function 8, a second monitoring function 9 and an LED driver 10. It will be appreciated that in practice the control circuit 5 could also comprise any other known feature which would be typical of a portable charging device, such as safety circuits, power regulators, sensors and so on, however such features are not relevant to the present invention so are not further described herein.

The charging device 1 also comprises an electrical charge inlet 11, by which the rechargeable battery 2 can draw an electrical charge for storage. The form of the electrical charge inlet 11 is described further below. Furthermore, the charging device 1 also comprises LEDs 12.

Referring to FIGS. 2-4, the charging device 1 further comprises an outer enclosure 13, which is generally rectangular in shape. It is provided with a contact-point wireless charging mechanism of a known type. This comprises a first magnetic conductor 14 and a second magnetic conductor 15, which are visible in FIG. 2. An inner end (not visible) of the first magnetic conductor 14 is connected to a positive terminal of the rechargeable battery 2, and an outer end 16 of the first magnetic conductor 14 is disposed in a first aperture 17 provided in the outer enclosure 13. Likewise, an inner end (not visible) of the second magnetic conductor 15 is connected to a negative terminal of the rechargeable battery 2 and an outer end 18 of the second magnetic conductor 15 is disposed in a second aperture 19 provided in the outer enclosure 13.

As is clear from FIG. 2, the first aperture 17 and the second aperture 19 are disposed in the same plane, and are spaced apart from one another in that plane.

Referring to FIG. 3, the charging device 1 further comprises a contact-point wireless electromagnetic charging plate 20, which comprises a positive panel 21 and a negative panel 22. As shown in FIG. 3 the charging device 1 can be disposed on the charging plate 20 with the first aperture 17 aligned with the positive panel 21 and the second aperture 19 aligned with the negative panel 22. Again, such a contact-point electromagnetic charging plate is known. This technology involves a magnetic connection between the charging plate 20 and the exposed conductors 14 and 15 of a charging device 1 to be charged. The charging device 1 is simply placed flat on the charging plate 20 in order to facilitate the electrical connection, which is a very simple and easy system to use, but it does require the correct type of charging plate, which is not widely available.

As stated above, the charging device 1 comprises LEDs 12. In this example three LEDs are provided, the operation of each of which provides a visual status display. As explained further below, a first LED 23 is illuminated after the control circuit 5 has detected the drawing of an electrical charge by the rechargeable battery 2, a second LED 24 is illuminated after an electrical charge has been drawn from the electrical charge outlet 3 or 4, but prior to the end of the pre-determined period of time, and a third LED 25 is illuminated in a flashing sequence after an electrical charge has been drawn from the electrical charge outlet 3 or 4 for the pre-determined period of time.

As is clear from FIGS. 2-4, the charging device 1 comprises a first electrical charging plug 26 and a second electrical charging plug 27. These are provided on the ends of cables 28 and 29 respectively. The outer enclosure 13 comprises cable and plug socket 31 for housing the cable 28 and first electrical charging plug 28 when not in use, and cable and plug socket 32 (most clearly seen in FIG. 3) for housing the cable 29 and second electrical charging plug 27 when not in use. This is a known structure, and it is convenient and ergonomic. As shown in FIG. 4, it allows the charging device 1 to be readily connected to a first mobile phone 33 of a first manufacture, as well as to a second mobile phone 34 of a second manufacture. Both kinds of mobile phone 33 and 34 can be connected at the same time, or they can be connected individually.

The first and second electrical charging plugs 26 and 27 are of a known construction, and allow the charging device 1 to be connected to most of the more popular mobile phones available. However, these electrical charging plugs 26 and 27 have had the capability to accept an electrical charge removed. As such, if a user were to attempt to charge the rechargeable battery 2 by connecting electrical charging plugs 26 and 27 to a supply of electrical charge, this would not work.

Referring back to FIG. 1, the first monitoring function 8 comprises a sensor and associated circuitry which detects the drawing of an electrical charge by the rechargeable battery 2. Therefore, when the charging device 1 is placed on the charging plate 20, so the first and second magnetic conductors 14 and 15 come into contact with the positive and negative panels 21 and 22 respectively, and an electrical charge is then drawn by the rechargeable battery 2, this is detected by the first monitoring function 8. The control circuit 5 comprises a switch mechanism, and when the first monitoring function 8 detects an electrical charge being drawn by the rechargeable battery 2, the switch mechanism is switched to allow an electrical charge to be drawn from either of the first or second outlets 3 and 4, which are in the form of plugs 26 or 27. In addition, the control circuit 5 operates the LED driver 10 to illuminate the first LED 23.

The second monitoring function 9 also comprises a sensor and associated circuitry, and it detects the drawing of an electrical charge from either of the plugs 26 or 27. When the second monitoring function 9 detects such an electrical charge being drawn from either of the plugs 26 or 26 the control circuit 5 then sends a signal to the timer function 6 to begin a countdown of the pre-determined period of time, which in this example is 30 minutes. In addition, the control circuit 5 operates the LED driver 10 to illuminate the second LED 24.

The countdown continues regardless of whether or not any electrical charge is drawn from either of the plugs 26 or 27. When the 30 minutes has elapsed the control circuit 5 switches the switch mechanism referred to above to prevent an electrical charge being drawn from either of the plugs 26 or 27. In addition, the control circuit 5 also operates the LED driver 10 to illuminate the third LED 25 in a flashing sequence.

The rechargeable battery is a 5000 mAh battery, which is capable of delivering approximately ten 30 minute charges before it needs to be recharged. As such, if it is fully charged it could be used up to 10 times in immediate succession, which makes the charging device 1 more commercially viable.

In use the charging device 1 operates as follows. Firstly the charging device 1 needs to be charged to at least a sufficient level to provide a full 30 minutes of charge to a connected mobile phone, and preferably it should be fully charged. Therefore, the charging device 1 is placed on the charging plate 20 so the first and second magnetic conductors 14 and 15 come into contact with the positive and negative panels 21 and 22 respectively, and an electrical charge is then drawn by the rechargeable battery 2. As explained above this is detected by the first monitoring function 8, and the control circuit 5 switches the switch mechanism to allow an electrical charge to be drawn from either of the plugs 26 or 27. In addition, the control circuit 5 operates the LED driver 10 to illuminate the first LED 23. The charging device 1 will need to be left on the charging plate 20 for some time for the rechargeable battery 2 to be fully charged for use.

When a user, for example a customer in a café, hires the charging device 1, it is removed from the charging plate 20 and taken to the customer's location. At this point the first LED 23 is illuminated to indicate that the 30 minute countdown has not yet begun. The user then attaches one or both of the plugs 26 and 27 to one or two mobile phones 33 and 34, and immediately an electrical charge is drawn. This is detected by the second monitoring function 9, and the control circuit 5 sends a signal to the timer function to begin the countdown. In addition, the control circuit 5 operates the LED driver 10 to illuminate the second LED 24, so the customer will know that their allotted period of time has begun. If the user disconnects their mobile phone or phones 33 and 34 this does not stop the countdown from continuing.

After 30 minutes the control circuit 5 switches the switch mechanism to prevent any further electrical charge being drawn from either of the plugs 26 or 27. In addition, the control circuit 5 also operates the LED driver 10 to illuminate the third LED 25 in a flashing sequence, so the customer will know that their allotted period of time has ended.

The user then returns the charging device 1 to the service provider, and it is placed once again on the charging plate 20. This is detected by the first monitoring function 8, and the control circuit 5 switches the switch mechanism to allow an electrical charge to be drawn from either of the plugs 26 or 27, and it operates the LED driver 10 to illuminate the first LED 23. As such, the charging device 1 can immediately be used for another 30 minutes by another user. Therefore, merely placing the charging device 1 on the charging plate 20 re-sets it. If the charging device 1 is not used immediately by another user it will remain on the charging plate 20 and fully recharge.

When the 30 minutes has elapsed the charging device 1 is no longer of any utility to the user, and there would be little motivation to remove it from the site where it was rented. The only way to re-set the charging device 1 is to place it once again on the charging plate 20, which is not a common device that a user is likely to own. In addition, when the charging device 1 is ready to be used, it is only going to be able to provide 30 minutes of usage, so even then it is not an attractive item to steal.

The charging device 1 has wide commercial uses. The service industry, including coffee shops, restaurants, hotels, spas, beauty salons, hospitals and so on would benefit because they could offer their customers a mobile phone charging service while they enjoy other services. This would improve customer service, help to boost sales and promote returning business. The provider is protected from customers taking advantage of them by using the service for long and unlimited periods of time and using up the battery power, because the charging device 1 will only work for 30 minutes.

The charging device 1 described above can be altered without departing from the scope of claim 1. For example, in one alternative embodiment (not shown) the control circuit is configured to allow a pre-determined period of charging to take place, regardless of whether that period of charging is continuous or interrupted. As such, if a user stopped using the charging device for a period, the timer function would stop. It would then begin again when the user began to use the charging device once more to operate or charge their mobile device.

In another alternative embodiment (not shown), the second signal is a visual clock displaying the time remaining of the pre-determined period of time. This allows the user to know how much longer their charging device would continue to operate.

In another alternative embodiment (now shown), the visual display comprises a further LED which is illuminated by the control circuit when the charging device is capable of providing an electrical charge for the pre-determined period of time. This allows a service provider to know when the charging device 1 can be hired to a user, and when it does not yet contain sufficient charge to be hired to a user and must be recharged for longer.

In further alternative embodiments (not shown) the electrical charge inlets comprise other known charging mechanisms including a USB micro input port, or an induction charging system.

Therefore, the present invention provides a charging device which can only be used for 30 minutes, and which can therefore be hired out to users for a fixed fee. It is also resistant to theft by its nature, because it will only work for 30 minutes, and it can only be re-set by being connected to its own particular recharging system.

1. A portable electrical charging device comprising a rechargeable battery, an electrical charge outlet by which said rechargeable battery provides an electrical charge, and a control circuit, in which said control circuit comprises a timer function, and in which said control circuit permits an electrical charge to be drawn from said electrical charge outlet for a pre-determined period of time only, by reference to said timer function.

2. The portable electrical charging device as claimed in claim 1 further comprising an electrical charge inlet by which said rechargeable battery can draw an electrical charge for storage, in which said control circuit comprises a first monitoring function which detects the drawing of an electrical charge by said rechargeable battery, and in which said control circuit is configured to only permit an electrical charge to be drawn from said electrical charge outlet for said pre-determined period of time, after it has detected the drawing of an electrical charge by said rechargeable battery.

3. The portable electrical charging device as claimed in claim 1 in which said control circuit comprises a second monitoring function which detects the drawing of an electrical charge from said electrical charge outlet, in which once said control circuit detects the drawing of an electrical charge from said electrical charge outlet it activates said timer function, and in which said control circuit is configured to prevent electrical charge being drawn from said electrical charge outlet after said pre-determined period of time has elapsed regardless of whether an electrical charge is drawn from said electrical charge outlet after said timer function has been activated.

4. The portable electrical charging device as claimed in claim 2 further comprising a visual display, in which said visual display displays at least a first signal after the control circuit has detected the drawing of an electrical charge by said rechargeable battery.

5. The portable electrical charging device as claimed in claim 4 in which said visual display displays a second signal after an electrical charge has been drawn from said electrical charge outlet, but prior to the end of said pre-determined period of time.

6. The portable electrical charging device as claimed in claim 5 in which said visual display displays a third signal after an electrical charge has been drawn from said electrical charge outlet for said pre-determined period of time.

7. The portable electrical charging device as claimed in claim 6 in which said second signal is a flashing LED.

8. The portable electrical charging device as claimed in claim 5 in which said second signal is a visual clock displaying the time remaining of said pre-determined period of time.

9. The portable electrical charging device as claimed in claim 2 in which said charging device comprises an outer enclosure, in which said electrical charge inlet comprises a contact-point wireless charging mechanism comprising a first magnetic conductor and a second magnetic conductor, in which an inner end of said first magnetic conductor is connected to a positive terminal of the rechargeable battery and an outer end of said first magnetic conductor is disposed in a first aperture provided in said outer enclosure, in which an inner end of said second magnetic conductor is connected to a negative terminal of the rechargeable battery and an outer end of said second magnetic conductor is disposed in a second aperture provided in said outer enclosure, in which said first aperture and said second aperture are disposed in the same plane, and are spaced apart from one another in said plane, in which said portable electrical charging device further comprises a contact-point wireless electromagnetic charging plate comprising a positive panel and a negative panel, and in which said portable electrical charging device is disposable on said charging plate with said first aperture aligned with said positive panel and said second aperture aligned with said negative panel.

10. The portable electrical charging device as claimed in claim 1 in which said electrical charge outlet comprises at least two electrical charging plugs each capable of being connected to an electrical device to be charged.

11. The portable electrical charging device as claimed in claim 10 in which said at least two electrical charging plugs are a different shape and configuration from one another.

12. (canceled)
